(19) United States
(12) Patent Application Publication
(10) Pub. No.: US 2012/0191615 A1
(43) Pub. Date: Jul. 26, 2012

(54) Secure Credit Transactions

(75) Inventor: Norman Schibuk, Merrick, NY (US)

(73) Assignee: SURIDX, INC., Wellesley, MA (US)

(21) Appl. No.: 13/360,266

(22) Filed: Jan. 27, 2012

Related U.S. Application Data
(63) Continuation-in-part of application No. 12/844,355, filed on Jul. 27, 2010.
(60) Provisional application No. 61/228,847, filed on Jul. 27, 2009.

(51) Int. Cl. G06Q 20/40

(52) U.S. Cl. 705/75; 705/76

(57) ABSTRACT

A system and method for engaging in a credit or debit transaction do not transmit an individual's account number to a vendor or merchant. The individual provides the account number to a transaction acquiring device (TAD). The TAD requires the individual to provide one or more pseudo-random numbers that identify the individual. These numbers are only obtainable from an authentication device that can be unlocked only by passing an authentication challenge. The TAD then provides transaction data to a credit or debit issuer and the vendor, but does not provide or store the account number. The issuer provides the merchant with an identifier other than the account number that is nevertheless unique to the individual. This identifier may be used to track the individual's purchase history or perform other business functions.

### CROSS-REFERENCE TO RELATED APPLICATIONS

This application is a continuation-in-part of U.S. application Ser. No. 12/844,355, filed Jul. 27, 2010, which claims the benefit of U.S. Provisional Application No. 61/228,847, filed Jul. 27, 2009. These applications are incorporated by reference in their entirety.

### TECHNICAL FIELD

The present invention relates to information security, and more particularly to prevention of unauthorized use of credit or debit accounts by limiting access to account numbers to authorized entities and processes.

### BACKGROUND ART

Identity theft and identity fraud in connection with credit and debit transactions are major problems affecting privacy and the economy. For example, 11.1 million people were victims of identity fraud in 2009. This fraud cost merchants about $54 billion, and cost cardholders and credit issuers about $500 million.

There are two broad categories of transactions: those in which a card is physically presented to a merchant or vendor (“card present” transactions), and those in which a card is not present. In card present transactions, identity theft may be perpetrated by an individual not a party to the transaction, such as a person who sees and copies an account number written on the card for later (unauthorized) use. The merchant itself may retain the account number for sale to a third party. Or, the merchant may innocently store the account number in a database that is then breached by a malicious third party who subsequently commits fraud. Such problems arise because the account number is stored in the merchant system in a manner that permits later use. Merchants may assume this risk, for example, to permit ease of subsequent purchases by repeat customers.

In card not present transactions, such as those conducted on the Internet, identity theft may be accomplished by a third party. For example, a phisher may provide an email or website that purports to be from a business partner or a merchant, asking for credentials such as a username and password. Once these data are entered by a victim, the phisher may use them to obtain unauthorized access to legitimate services. Alternatively, a “man in the middle” may intercept such communications between a victim and a legitimate website.

It is known in the art to encrypt communications between an issuer and either a merchant (in card present situations) or a purchaser (in card not present situations). For example, U.S. Publication 2009/0132813 entitled “Apparatus and Methods for Providing Scalable, Dynamic, Individualized Credential Services Using Mobile Telephones” discloses a system and method for using a mobile electronic device, such as a smartphone, to authenticate an individual by requiring the use of an encryption certificate that can only be accessed when the individual unlocks the device by entering certain data unique to the individual. Similarly, U.S. Publication 2011/0022835 entitled “Secure Communication Using Asymmetric Cryptography and Light-Weight Certificates” discloses a system and method for providing encrypted communications over unsecured data communications channels without a traditional public key infrastructure. The contents of these publications are incorporated herein by reference in their entireties.

In the prior art, a purchaser must present a credit or debit account number to transact business with a vendor. Whether encryption schemes are present or not, current transactional systems rely on vendors to not re-use these numbers for later, unauthorized transactions. Such reliance is necessary because these transactional systems must expose the account numbers to the vendors in order to function. Moreover, long-term storage of these numbers presents a risk due to the possibility that the storage system will be compromised by a malicious third party. While encryption of the account numbers provides a partial solution, once stolen, encrypted numbers may be decrypted given enough processing resources.

### SUMMARY OF ILLUSTRATED EMBODIMENTS

Various embodiments of the invention solve the aforementioned problems in both the card present (CP) and card not present (CNP) environments, by removing the need to expose a debit or credit card number to a merchant system in the first instance. Only a transaction acquiring device (TAD), such as a point-of-sale terminal, stores the number, and only in volatile memory. Such embodiments may be advantageous in jurisdictions that impose on merchants burdensome data security regulations regarding use and storage of such information. Further, in some embodiments, the card number is never transmitted even to the issuer; instead, only a transaction-specific number that is a one-way hash of the card number and an encryption seed is sent. The seeds themselves are securely obtained from the issuer prior to entering the transaction, and the hash value is calculated by the TAD. Replay attacks are thereby eliminated, and any data communication network, including the Internet, may be used to transmit transactional information without danger of identity theft.

Also, in various embodiments, the issuer returns to the vendor a unique identifier, associated with the purchasing account, that may not be used to effectuate a later transaction. This identifier may be used for various purposes by the merchant, such as customer relationship tracking and aggregate sales analysis. If the merchant's database systems are later compromised by a malicious attacker, none of the information therein may be used to commit identity fraud.

In similar embodiments, a card number is decryptably encrypted by the TAD before it is stored in a merchant system, so it is recoverably transmitted to the issuer. These embodiments are not as secure because the card number conceivably may be recovered if the encryption scheme is compromised. However, these embodiments may require fewer adjustments to existing point-of-sale infrastructure.

In some CNP embodiments, either at a point-of-sale or not, an individual uses an authentication device such as a smartphone to compute information (other than a credit or debit card number) that an issuer may use to uniquely identify the individual and an account number. Again, no card number is needed; in fact, no original, physical card needs to be issued. Instead, the issuer authorizes a transaction using a one-time password formed from a unique identifier associated with the individual's authentication device (e.g., the telephone number of a smartphone) and information stored only in that authentication device (e.g., a private encryption key).

Authorization may occur transparently to the individual, and may rely on standard authentication of the individual to the authentication device, such as entering a username and password or providing a biometric input. Therefore, even if the authentication device is stolen, further transactions using the device may be remotely disabled as soon as the device is reported missing. Such a report typically will be filed long before even the standard log-in authentication for the device is cracked by the thief. Recovery is simple: if the device is lost, a new device is obtained having new security credentials on it, and the new device is registered with the issuer out-of-band.

Therefore, in a first embodiment there is provided a method for engaging in a transaction with an individual having possession of a credit or debit card, the card having a primary account number digitally encoded thereon, the primary account number being uniquely associated with an issuer. The method includes, in a transaction acquiring device, receiving the primary account number using a first input and receiving an encryption seed using a second input. The encryption seed must have been previously obtained from the issuer by an authentication device of the individual, wherein the individual must have passed an authentication challenge of the authentication device before the encryption seed may be received by the transaction acquiring device. Next, in the transaction acquiring device, the method calls for applying a one-way hash function to a combination of the primary account number and the encryption seed, thereby producing a transaction hash. Next, the method requires transmitting the transaction hash and encryption seed to the issuer using a data communication network according to a financial transaction standard, wherein the primary account number is not transmitted to the issuer. Finally, the method include receiving, from the issuer using the data communication network according to the financial transaction standard, an indication that the issuer recovered the primary account number from the transaction hash.

The authentication device may be, for example, a smartphone. The authentication challenge may include entry of a username and password into the authentication device. Receiving the primary account number may include passing the credit or debit card through a magnetic stripe reader. The transaction acquiring device may have a numeric keypad, and receiving the encryption seed may including using the numeric keypad. The method may be extended by further deleting all electronic storage of the primary account number within the transaction acquiring device. The primary account number may be recovered from the transaction hash by using the hash to retrieve a record from a database indexed by transaction hashes, the record including the primary account number and the received encryption seed. The method may be extended by receiving, from the issuer using the data communication network according to the financial transaction standard, an indication that the transaction is authorized.

In a second embodiment there is provided a method for authorizing a requested transaction. This method includes two phases: an initialization phase, and a transaction phase occurring after the initialization phase. During the initialization phase, the method includes generating an encryption seed in response to receiving a request from an authentication device of an individual, wherein the individual must pass an authentication challenge of the authentication device before the request may be received. Also in the initialization phase, the method calls for forming an issuer hash by applying a one-way cryptographic hash function to a combination of the generated encryption seed and a primary account number that is uniquely associated to the individual. Finally in the initialization phase, the method requires storing a record in a database, the record including the issuer hash, the primary account number, and the generated encryption seed. In the transaction phase, the method requires receiving a transaction request from a merchant that includes an encryption seed and a transaction hash. Next, the method requires retrieving, from the database, a record that includes the transaction hash. Finally, the method includes determining to authorize the transaction only if the received encryption seed matches an encryption seed contained in the retrieved record. The encryption seed may be obtained from a pseudorandom number generator.

In a related embodiment, the transaction phase is extended by further retrieving the primary account number of the individual from the record; retrieving a transaction amount from the transaction request; and determining to authorize the transaction only if a balance associated with the primary account number is greater than the transaction amount. In a separate related embodiment, the method is extended by generating identification data that are unique to the individual but different from the primary account number of the individual. This latter embodiment may be extended by transmitting a determined authorization and the identification data to the merchant.

### BRIEF DESCRIPTION OF THE DRAWINGS

The foregoing features of the invention will be more readily understood by reference to the following detailed description, taken with reference to the accompanying drawings, in which:

FIG. 1 is a block diagram showing functional components of a first system embodiment of the invention that processes card present (CP) credit or debit transactions;

FIG. 2 is a flowchart showing processes to initialize an authentication device for CP transactions in accordance with a first method embodiment of the invention;

FIGS. 3A and 3B comprise a flowchart showing processes for completing a transaction in accordance with the first method embodiment;

FIGS. 4A and 4B comprise a flowchart showing processes for completing a pre-authorized CP transaction, in accordance with a second method embodiment;

FIG. 5 is a flowchart showing processes for pre-authorizing a CP transaction in accordance with a third method embodiment;

FIG. 6 is a flowchart showing processes for completing a CP transaction using a transitional system, in accordance with a fourth method embodiment;

FIG. 7A is a schematic block diagram showing the client-facing processes of an exemplary merchant transaction using a light-weight certificate;

FIG. 7B is a schematic block diagram showing the server-facing processes of the exemplary merchant transaction of FIG. 7A; and

### DETAILED DESCRIPTION OF SPECIFIC EMBODIMENTS

Definitions. As used in this description and the accompanying claims, the following terms shall have the meanings indicated, unless the context otherwise requires:

A “primary account number” (or PAN) is a numeric code that identifies a credit or debit account. This number may be embossed on a credit or debit card, encoded in a magnetic strip on the back of the card, or both. The PAN is typically between 14 and 16 digits, although embodiments of the invention may use a PAN having more or fewer digits.

An “issuer” is an entity that has issued a credit or debit card that is associated with a PAN. An issuer may be, for example, a bank or credit union in which a card holder has established an account to which a debit card is tied. An issuer may also be any entity that has established a credit account identified by a PAN on a credit card, such as a retail store, airline, or restaurant.

A “transaction acquiring device” (or TAD) is an electronic device that is used to acquire a PAN for use in a credit or debit transaction. Some examples of transaction acquiring devices are, without limitation, point-of-sale terminals (especially those having peripherals with a card scanner plus keypad and/or touchscreen), automated teller machines, airline check-in kiosks, and vending machines.

A “financial transaction standard” is a standard adopted for data interchange between a transaction acquiring device and an issuer. One such standard is ISO 8583, “Financial transaction card originated messages—Interchange message specifications.”

A “card present transaction” (CP transaction) is a credit or debit transaction in which a purchaser must present a physical credit or debit card to a seller at a point of sale, such as a retail store, to complete the transaction. A transaction acquiring device typically is used to scan a magnetic strip or a chip on the presented card to automate the process of inputting the PAN into a merchant transactional system. While magnetic scanners are commonplace, other systems known in the art, such as RFID or near field communications, may be used to read the PAN.

A “card not present transaction” (CNP transaction) is a credit or debit transaction that may be completed without requiring a purchaser to present a physical credit or debit card to a seller. CNP transactions include telephone orders, mail orders, fax orders, and orders placed using a web site. In the prior art, purchasers are typically required to submit a PAN with their order by filling out a field or blank in a form.

A “card security code” (or CSC) is a numeric code, separate from a PAN and typically three or four digits, that is printed on a credit or debit card. A CSC is often required by law or custom to be presented with a PAN to complete a CNP transaction. As is known in the art, a CSC also may be known as a card verification value (CVV or CVV2), card verification value code (CVVC), card verification code (CVC or CVC2), card code verification (CCV), or card verification data (CVD).

A “personal identification number” (or PIN) is an alphanumeric code, distinct from a PAN and from a CSC, that provides a knowledge authentication factor to CP and CNP transactions. A PIN may be used in addition to physical presentation of a card, or in addition to inherence factors such as a fingerprint, signature, or other biometric identifier, to provide multi-factor authentication for such transactions.

An “authentication device” is an electronic device, for example a smartphone, that authenticates one party in a transaction to the other party in the transaction, using techniques in accordance with embodiments of the invention.

### Card Present Transactions: System Overview

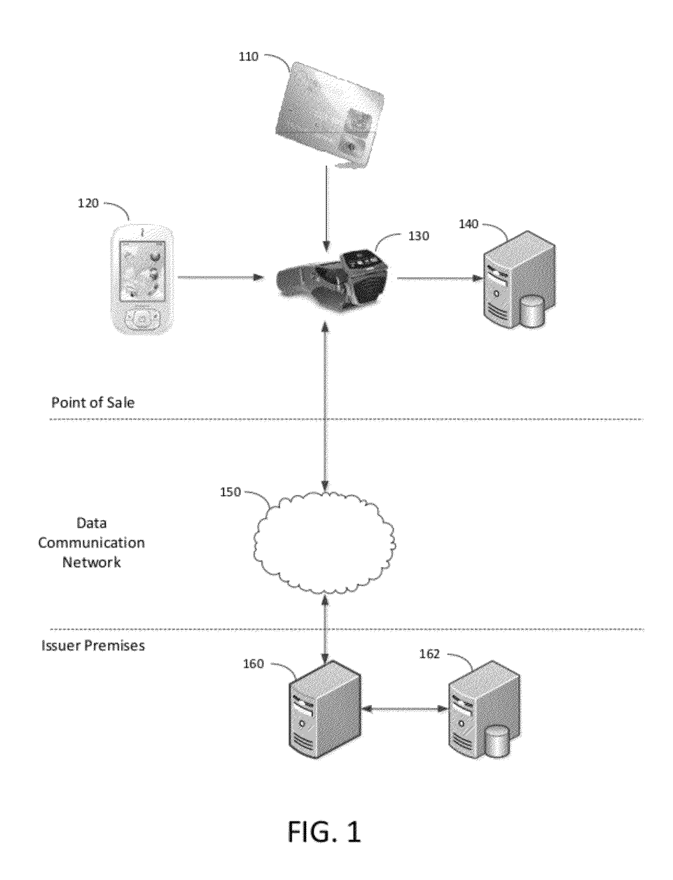

FIG. 1 is a block diagram showing functional components of a system in accordance with an embodiment of the invention that processes card present (CP) credit or debit transactions. In this block diagram, arrows indicate direction of data flow. FIG. 1 is divided by two dashed lines that represent the boundaries between three physical entities, as indicated: a point of sale, a data communication network, and an issuer premises. The point of sale may be, for example, a retail establishment, an automated teller kiosk, a vending stall, or other such location. The data communication network may be, for example, the Internet, a cellular telephone network, a satellite network, or a private wired network. The issuer may premises include a credit card processing center or portions thereof, and need not be owned directly by the issuer.

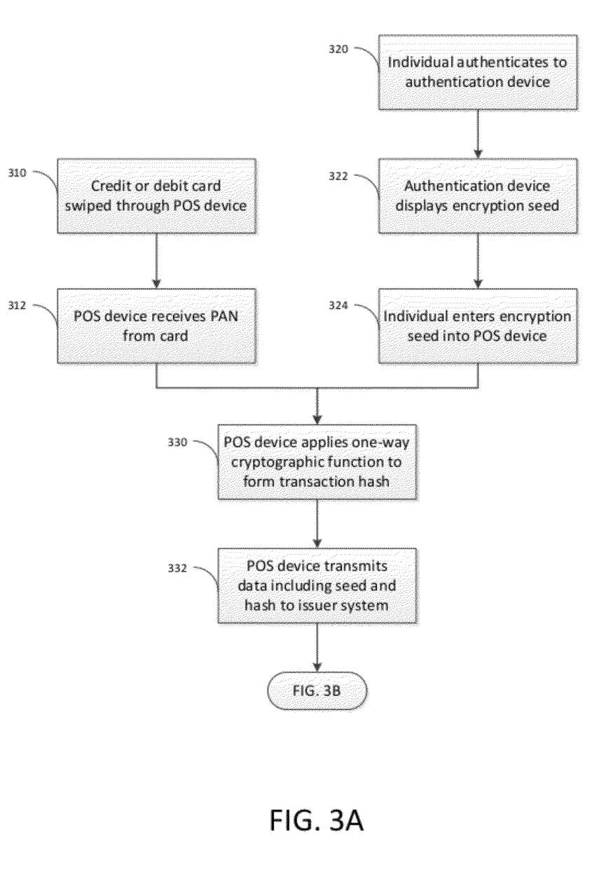

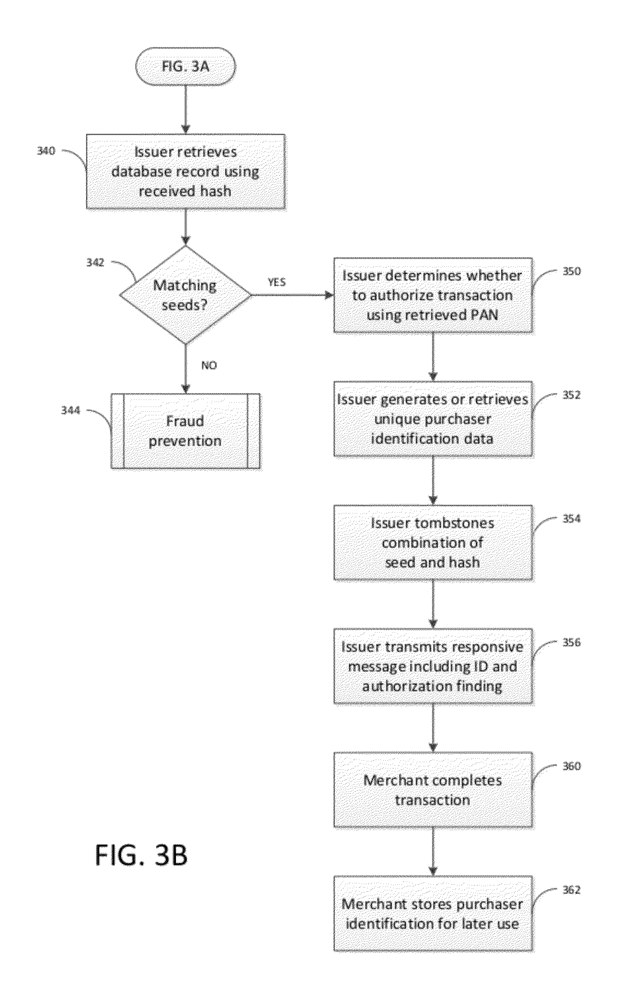

In accordance with one embodiment of the invention, an individual brings a credit or debit card 110 and an authentication device 120 (shown here as a smartphone) to a point of sale. Once the individual wishes to engage in a transaction, the individual presents information obtained from the credit card 110 and from the authentication device 120 to a transaction acquiring device (TAD) 130, shown here as a point of sale terminal. Typically, the TAD 130 receives the primary account number (PAN) of the card 110 when the card is passed (swiped) through a magnetic stripe reader that forms part of the TAD. The TAD 130 also receives certain cryptographic information stored on the authentication device 120 by manual entry, for example using a numeric keypad. The TAD 130 performs various computations on these received data, described below in connection with FIG. 3, and transmits TAD data to a merchant system 140 for storage. Importantly, the transaction acquiring device 130 does not transmit the PAN to the merchant system 140. Therefore, the merchant system 140 does not receive (and cannot store) the PAN.

The TAD 130 combines the TAD data with other transaction data, such as a sale amount, a date and time, a merchant identifier, and so on, to form a transaction request. This other data may be obtained by programming the TAD 130, or by contacting a separate merchant system (not shown). The request is sent, via a data communication network 150, to a payment processing system 160 on the premises of an issuer associated with the card 110. The particular issuer is determined in accordance with techniques known in the art, for example by analysis of certain digits of the PAN. The payment processing system 160 determines whether to authorize the transaction as a function of the TAD data and the other data in the transaction request, typically utilizing a database system 162. The payment processing system 160 then forms and transmits a responsive message, through the data communication network 150 to the TAD 130, that indicates whether the transaction is authorized. In accordance with this embodiment, the responsive message includes unique purchaser identification data that are different from the PAN. The TAD 130 may store the purchaser identification data in the merchant system 140 for transaction reconciliation and for further purposes, such as sales and marketing analysis and customer relationship tracking At no point does the merchant system 140 ever receive or store a PAN.

Credit and debit cards 110 are well known in the art. The authentication device 120 may be, among other things, a smartphone, personal digital assistant (PDA), laptop computer, or any dedicated hardware device with a display screen, such as a security token. The TAD 130 may be any electronic device that is used to acquire PAN data to be used in transacting business; for example, a point-of-sale terminal, an automated teller machine, an airline check-in kiosk, or a vending machine. The merchant system 140 may be any computing system known in the art that is used to facilitate purchases, perform sales and marketing analyses, track customers, and/or perform similar business functions. The data communication network 150 may be any data communication network known in the art, including the Internet, a broadcast radio network, an optical or electrical cable network, a satellite network, or any combination of these. The payment processing system 160 may be any computing system known in the art that is used by an issuer to process credit or debit transactions (such as an automated clearing house system), and the database system 162 may be any database system that is interoperable with the payment processing system. Transmission of data through the data communication network is performed according to a financial transaction standard known in the art.

In accordance with various embodiments of the invention described in more detail below, encryption seeds are used to encrypt a PAN according to a one-way cryptographic hash function. Such hash functions are well known in the art, and include MD5, RIPEMD-128, and SHA-512; unless otherwise specified, the scope of the invention is not limited to the use of any particular hash function. The particular hash function is shared between the TAD 130 and the payment processing system 160 (or one of its subsystems). Different issuers may choose different hashes, so TAD manufacturers may program each TAD with a variety of hashing algorithms to be compliant with issuer requirements.

### Card Present Transactions: Method Using Encryption Seeds

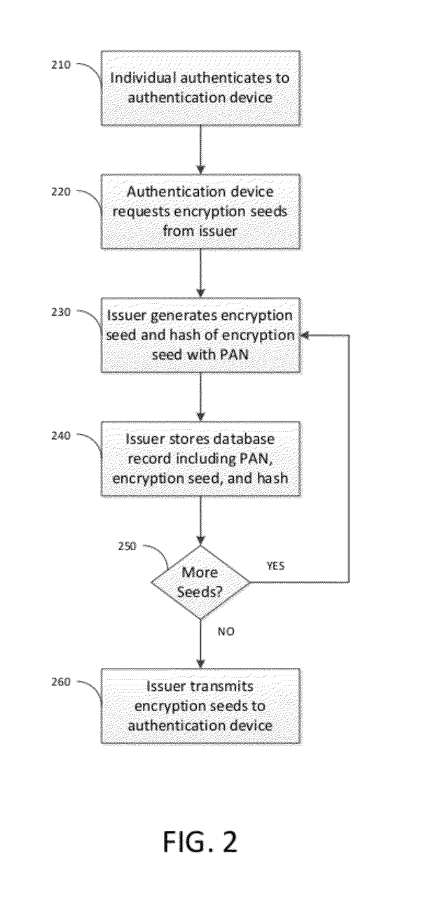

FIG. 2 is a flowchart showing processes to initialize an authentication device 120 for CP transactions in accordance with a first method embodiment of the invention. The method begins with a process 210 in which an individual authenticates himself or herself to an authentication device. Such authentication may take any form known in the art, especially entry of a username and password or provision of biometric data such as fingerprint data. In process 220 the authentication device requests one or more encryption seeds from an issuer. This may be accomplished, for example, by using a network-enabled software application designed for this purpose. Such an application may be manually downloaded from a website of the issuer by the individual, or in the case of a dedicated device, the application may be stored in the device in hardware, firmware, or a combination of these. The application typically will use an encryption algorithm to encrypt communications with the issuer, to mitigate man-in-the-middle attacks. The particular encryption algorithm used may be known in the art or, as the software application is provided by the issuer itself, it may be proprietary to the issuer and generally unknown to anyone else.

In process 230, the issuer generates an encryption seed and hashes it with the PAN of the requesting individual according to the issuer-designated algorithm. The PAN is obtained by the issuer from data in the request generated by process 220. The encryption seed may be generated, for example, using a pseudorandom number generator (PRNG) known in the art, or by any other method that generates a sequence of numbers having desirable statistical randomness. The encryption seed is preferably a six digit number, but various embodiments may use other numbers of digits. The encryption seed and PAN are combined, for example by concatenation, and the one-way cryptographic hash function is applied to produce an issuer hash. Provided that the hash function is suitably collision-resistant, a given hash practically may be calculated only by combining the given encryption seed with the PAN in the manner described above.

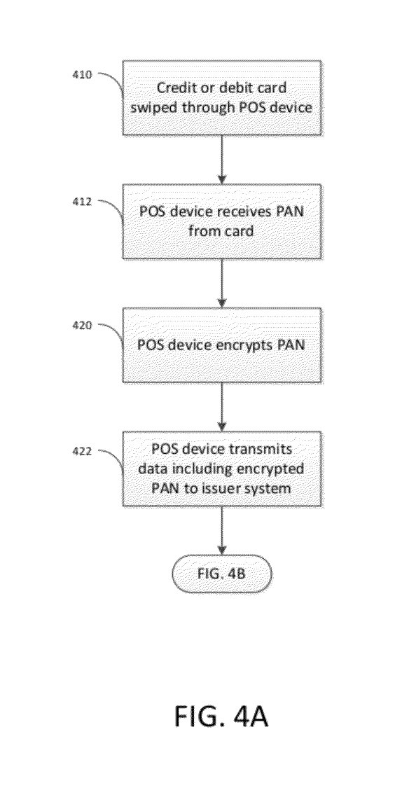

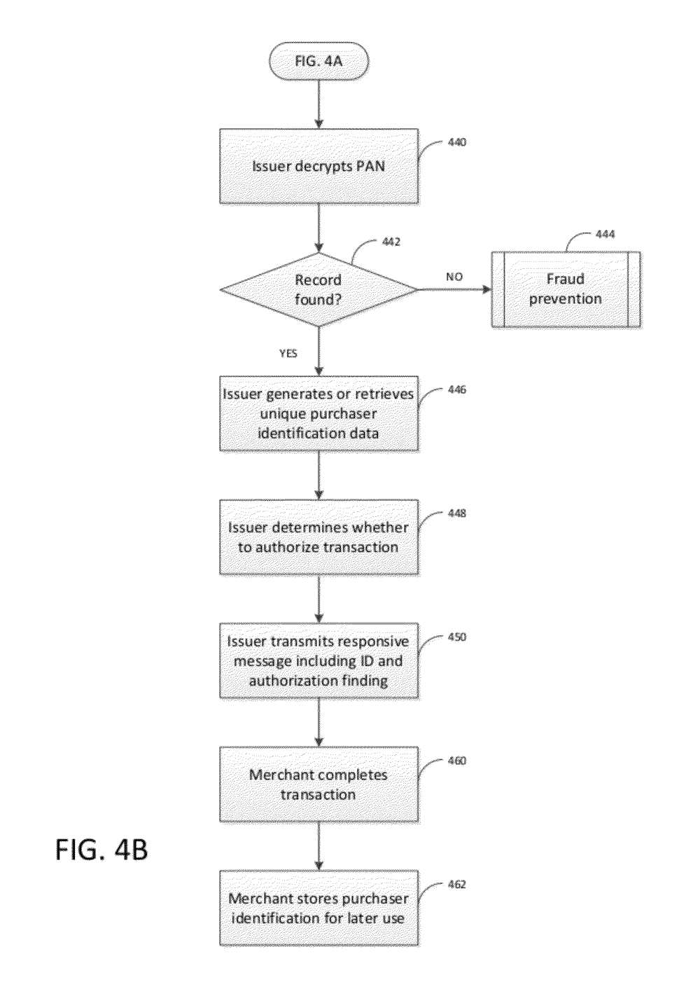

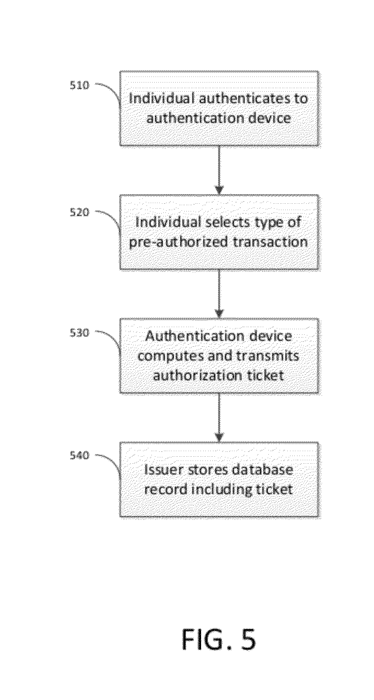

In process 240, the issuer stores a database record in a database such as database system 162. Each record is indexed by the issuer hash, and stores the PAN and the encryption seed, along with any other data relevant to the issuer such as: the time of the request, the time of the hash generation, a unique identifier of the authentication device that made the request in process 220, a unique purchaser identifier (described in more detail below), whether this issuer hash is still valid for use in a transaction, a pre-authorization amount or type (as explained below in connection with FIGS. 4 and 5), and the like. In process 250, the issuer determines from the request whether there are more seeds to be generated. If so, the method returns to process 230 for generation of another encryption seed. If not, the method continues to process 260, in which the issuer transmits the generated encryption seeds (but not the hashes) to the authentication device for secure storage. Thus, the issuer hashes are known only to the issuer.

The authentication device may store a pool or cache of encryption seeds to reduce the number of initialization requests that must be made. The authentication device may request a number of seeds in response to user input, or it may do so automatically. Automatic requests may be made in response to the seed pool having fewer than a given number of seeds, or on a periodic basis, or according to another rule set by the issuer or by the individual. Alternatively, the authentication device may not store a seed pool, in which case a new seed is requested from the issuer each time a transaction is entered. Such embodiments may be useful in situations where the authentication device is shared among a number of different individuals, for example within a family.

FIG. 3 is a flowchart showing processes for completing a card present transaction in accordance with the above processes, and is split into FIGS. 3A and 3B for clarity. The method of FIG. 3 typically occurs at a merchant premises after a customer has selected a good or service for purchase. In this embodiment, the customer possesses a credit or debit card.

The method begins in process 310, in which the credit or debit card is passed (swiped) through a transaction acquiring device, in this case a point-of-sale (POS) terminal. In process 312, the POS device receives a PAN from the card, typically by reading a magnetic stripe on the back of the card or a chip embedded within the card. Optionally, the POS device may request that the individual enter a PIN or card security code (CSC) on a keypad. At this point, the POS device may pause and display a message that it is awaiting entry of an encryption seed. This pause may be triggered, for example, if the POS device reads data from the magnetic stripe indicating that the associated credit or debit account is enabled for such use, or if the device receives keypad entry of a special CSC such as 0000 (four zeroes).

In process 320, the individual authenticates to an authentication device, as in process 210. In process 322, the authentication device displays an encryption seed. The display may be prompted by the user activating the software application described above, or by a signal transmitted from the POS terminal to the authentication device for this purpose. In the latter case, the POS device may optionally request a unique identifier associated with the authentication device, such as the individual's mobile telephone number, and send a signal to that number requesting the display. Alternatively, the POS device may transmit such a signal, using communication methods known in the art, that has a range short enough (e.g., between one meter and three meters) that only the individual's authentication device may receive and process it. In process 324, the individual enters the displayed encryption seed into the POS device, for example using a numeric keypad integral to the device. Although the above processes of FIG. 3 have been described sequentially, they may be performed in any order. However, after both processes 312 and 324 have been concluded, the POS device has received both the PAN from the card and an encryption seed.

In process 330, the POS device applies a one-way cryptographic hash function to a combination of the PAN and the encryption seed to form a transaction hash. The hash function and method of combining the PAN and seed must be the same as described above in connection with process 230, so that the POS device duplicates the processes used by the issuer to generate the issuer hash. If the PAN and encryption seed were properly input into the POS device, process 330 will generate a transaction hash identical to an issuer hash. However, if either the PAN or the encryption seed are incorrect, the POS device will generate a transaction hash that is not an issuer hash.

In process 332, the POS device transmits data that include the seed and transaction hash (but not the PAN) to an issuer system 160 according to a financial transaction standard, for example ISO 8583. The issuer may be determined, for example, by analyzing the digits of the PAN according to techniques known in the art. Other data that are generally transmitted to the issuer system include, for example, a transaction amount, a date and time, a card expiration date, a merchant type, a merchant identifier, and so on. The POS device also may transmit data indicating the transaction to the merchant system 140 for record keeping purposes. The POS device then deletes all electronic storage of the PAN. In this way, the PAN advantageously is never stored outside the POS device. In particular, the PAN is never stored in the merchant system 140, and the PAN is never transmitted across the data communication network 150.

The method continues as shown in FIG. 3B. In process 340, the issuer retrieves a database record using the received transaction hash. As described above in connection with process 240, the issuer maintains a database having records indexed by issuer hash. However, the received transaction hash will equal an issuer hash if and only if the PAN and encryption seed were properly combined in process 330. Therefore, absent a hash collision, the database will include exactly one record indexed by the received hash. Process 340 retrieves that record according to database query techniques known in the art.

In process 342, the issuer performs a comparison to determine whether the previously stored encryption seed contained in the record matches the received encryption seed. If not, various fraud prevention measures may be activated in process 344. Such measures may include transmitting to the merchant an indication that the transaction is unauthorized due to possible fraud. In the case that only a single record was associated with the received encryption seed, such measures also may include flagging the PAN associated with the retrieved record for suspicious activity, and notifying the merchant of possible fraud. Other fraud prevention measures known in the art may be taken at this point.

Alternatively, in the extremely rare case that the database includes more than one record associated with the received transaction hash due to a hash collision, the processes 340, 342 retrieve all such records from the database, and each record is traversed sequentially until a record is found in which is stored the received encryption seed. If no such records are found, then it is likely that a hash collision was deliberately created using a false encryption seed and false PAN, and the method continues to process 344 as described above.

If a record with a matching seed was located, the method proceeds to process 350, in which the issuer determines whether to authorize the transaction using a PAN retrieved from the database record. Such processes include comparing a received transaction amount to a credit limit and balance, determining a level of risk for the proposed transaction, and making other such decisions known in the art.

In process 352, the issuer generates (or retrieves from the database) unique purchaser identification data. These data permit the merchant to perform customer tracking and other business functions without being in possession of a usable PAN. The unique purchaser identification data may be constructed to have the same data format as a PAN for ease of integration with existing merchant systems; that is, it may be a 14 to 16 digit number. The purchaser identification data may be created, for example, by selecting a pseudo-random number having the appropriate number of digits at the time the account is established, or by any other appropriate method. Or, the unique purchaser identification data may be an encryption certificate number associated with the individual. Such a certificate number may be generated in connection with identity services, as described in U.S. patent application Ser. No. 12/844,355, filed Jul. 27, 2010 and entitled “Secure Communication Using Asymmetric Cryptography and Light-Weight Certificates”. These identification data are stored in the database, and are uniquely associated with the account, not with any individual transaction.

In process 354, the issuer tombstones (invalidates) the combination of seed and transaction hash. This is done by updating the retrieved record to indicate that it may not be used for a future transaction. If a large number of stale records thereby accumulate, these records may be eventually archived or deleted from the database according to a process known in the art (not shown). In various embodiments, the processes 350 through 354 may occur in any order.

In process 356, the issuer transmits to the merchant, according to the financial transaction standard, a responsive message that includes the unique purchaser identification data and the determination from process 350. In process 360, the merchant completes the transaction, provided it has received authorization to do so from the issuer. If no such authorization was received, the merchant may employ other processes known in the art to retry the transaction, such as asking the purchaser to swipe the card again, input a PIN, try a different card, and so on. In process 362, the merchant stores the purchaser identification data in a merchant database for later use, as described above.

### Card Present Transactions: Encrypted PAN

In some situations, the issuer may be unable or unwilling to generate encryption seeds for distribution to authentication devices as in the first method. However, the issuer may be able to participate in encrypted communications, and the transaction acquiring device (e.g., the POS terminal) may be able to encrypt data according to a method decryptable by the issuer. For example, the POS terminal may encrypt the data using a public key of the issuer having a matching private decryption key. In this situation, a second method embodiment of the invention is able to preserve the advantages of preventing a merchant from directly accessing or storing a PAN, and preventing the PAN from being transmitted using the data communication network 150.

FIGS. 4A and 4B comprise a flowchart showing processes for completing a pre-authorized CP transaction, in accordance with the second method embodiment. The method begins with two processes 410, 412 in which a credit or debit card are swiped through a transaction acquiring device (e.g., a POS device) that receives the PAN from the card. These processes are analogous to the processes 310, 312. However, unlike the method shown in FIG. 3A, no encryption seeds are used. Instead, in process 420 the POS device encrypts the PAN according to a scheme that is decryptable only by the issuer. For example, the POS device may encrypt the PAN according to a symmetric encryption scheme in which a secret key used for both encryption and decryption is shared by both the authentication device and the issuer. Or, the POS device may encrypt the PAN according to an asymmetric encryption scheme, by encrypting the PAN using a public key of the issuer so that the encrypted PAN may only be decrypted by using a private key of the issuer. In process 422, the POS device transmits data, including the encrypted PAN, to the issuer system according to a financial transaction standard. Although this method differs from that of FIG. 3A in that no issuer-generated encryption seed is present, nevertheless these two embodiments share a similar advantage: in both cases, the (unencrypted) PAN is never permanently stored in any merchant system.

The second method embodiment continues as shown in FIG. 4B. In process 440, the issuer decrypts the received PAN according to the encryption scheme just described. In process 442, the issuer attempts to retrieve a record associated with the decrypted PAN. If no such record can be located, then it is likely that a false PAN was encrypted with the issuer's public key, so the issuer may undertake fraud prevention measures in process 444, such as those described in connection with process 344. If the record is properly retrieved, in process 446 the issuer generates or retrieves unique purchaser identification data, as in process 352 described above. In process 448, the issuer determines whether to approve the transaction according to the received transaction parameters. Processes 450, 460, and 462 correspond to processes 356, 360, and 362 described above.

### Card Present Transactions: Pre-Authorization

The above methods may be augmented through the use of pre-authorization techniques, by which certain restrictions are placed on use of a credit or debit card. For example, a parent may have a credit card that has a high limit, but give the card to a child on condition that only transactions below a certain amount per day are authorized. Other restrictions may be pre-authorized. In accordance with a third method embodiment of the invention, an issuer generates a transient account number that is related to the primary account number, but includes these additional restrictions. The transient account number, or authorization “ticket,” is used in the above processes in conjunction with the PAN to complete a transaction.

FIG. 5 is a flowchart showing processes for pre-authorizing a CP transaction in accordance with a third method embodiment. In process 510, an individual authenticates to the authentication device, as in process 210. In process 520, the individual selects pre-authorization data to limit the transaction. For example, the individual may select that the transaction take places only over Internet or only with possession of the card, that the transaction must be with a particular merchant or at a particular physical store, or that the purchase price has a ceiling or floor; other such restrictions fall within the scope of the invention. In process 530 the authentication device computes an authorization ticket, which may be simply a pseudorandom number, and transmits this number and the pre-authorization data to the issuer. Also transmitted are data identifying the authentication device (and thereby uniquely identifying the individual). For example, if the authentication device is a smartphone, the data may be the individual's telephone number. In process 540, the issuer stores a database record including the ticket, the identifying data, and the pre-authorization data. At this point, the issuer may return a status code to the authentication device, indicating whether the transaction was successfully pre-authorized. Pre-authorization requests may be rejected if they exceed limitations on the individual's account, for example if a request is for an amount greater than the individual's funds available (as determined using the identifying data), or is associated with a transaction type (e.g. Internet sales) that are prohibited by the issuer generally, or prohibited for the particular individual. Other, more complicated business rules (e.g., no Internet sales above $500) that are configured by the issuer or the individual may also be employed to reject pre-authorization requests.

Once the authorization ticket has been generated, it may be employed in transactions in addition to the PAN. Thus, the ticket is transmitted to the issuer by the TAD along with either the transaction hash (in accordance with the method of FIG. 3) or the encrypted PAN (in accordance with the method of FIG. 4). In either case, the issuer determines whether to authorize the transaction using a combination of the retrieved PAN and the authorization ticket, in a modification of process 350 or process 448. In the modified issuer process of a pre-authorization embodiment, the received ticket is retrieved from an issuer database such as database system 162, and the received transaction data are compared to the retrieved restrictions associated with the ticket, according to methods known in the art. The methods are otherwise identical.

### Card Present Transactions: Transitional System

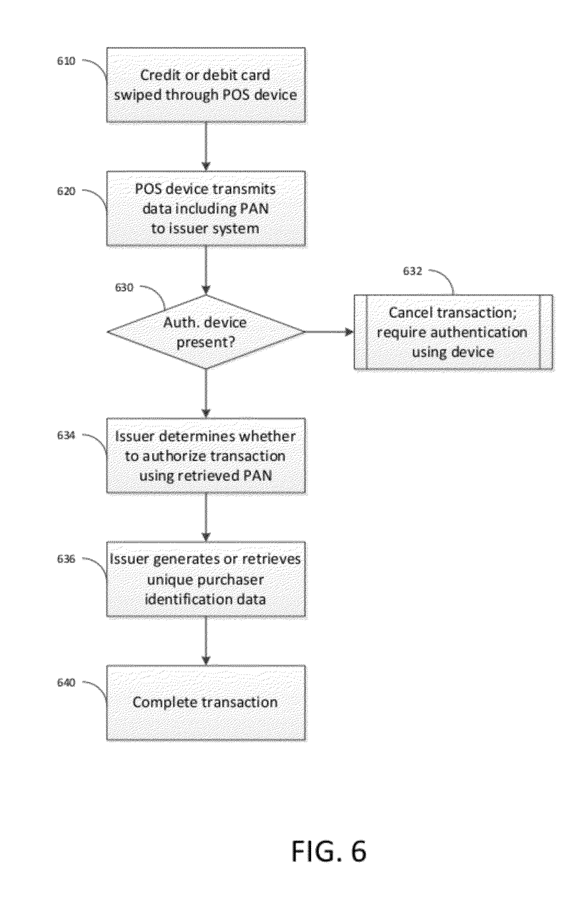

FIG. 6 is a flowchart showing processes for completing a CP transaction using a transitional system, in accordance with a fourth method embodiment. Like the two previously described methods, the third method ends without the merchant storing the PAN for replay transactions. However, unlike the previous two methods, the third method requires no modification to existing systems, so an unscrupulous merchant could bypass it as existing POS devices transmit the PAN to the merchant system without encryption. This method is described because it advantageously permits issuers to provide, to participating merchants, unique purchaser identification data other than the PAN for use in customer relationship tracking and marketing research, thereby permitting these merchants to easily and inexpensively comply with data privacy laws but without requiring the merchants to modify their existing systems.

The method begins with process 610 that is analogous to processes 310, 510 in which the card is swiped through the POS device. In process 620, the POS device transmits the (unencrypted) PAN to the issuer system according to a financial transaction standard, as is currently done in the art. In process 630, the issuer determines whether an authentication device has been associated with the received PAN and the merchant is configured to use one of the first two methods. For example, the issuer may determine whether the methods of FIG. 2 or FIG. 5 have been applied to this PAN at any time in the past. If so, in process 632 the issuer cancels the transaction and sends an error message to the POS device, requiring the use of an authentication device-enabled transaction. At this point, the POS device erases the PAN from its memory, and does not transmit the PAN to the merchant system 140. If the merchant is unable to execute one of the more secure methods of FIG. 3 or 4, in process 634 the issuer determines whether to authorize the transaction using the received PAN, as in process 350 described above. In process 636, the merchant generates or retrieves unique purchaser identification data as described above. In process 640, the issuer completes the transaction as described above in connection with processes 356, 360, and 362.

The transition strategy just described allows for the continued use of credit and debit cards as systems are migrated to authentication devices. Advantageously, the PAN is never transmitted to the merchant system 140; instead, the merchant uses the unique purchaser identification data for customer tracking and analysis. Although the PAN is transmitted across the data communication network 150, it is already common practice in the art to do so.

### Card Not Present Transactions

In some cases, an individual may wish to purchase a product or service, but a credit or debit card is not present at a point of sale. One method for transacting without a credit or debit card was described in the aforementioned U.S. patent application Ser. No. 12/844,355, especially FIGS. 4, 5A and 5B and paragraphs 74-97 of the written description associated therewith. This method involved the creation and management of a light-weight encryption certificate (LWC). An overview of executing a transaction based on this method is reiterated herein, with improvements noted as appropriate.

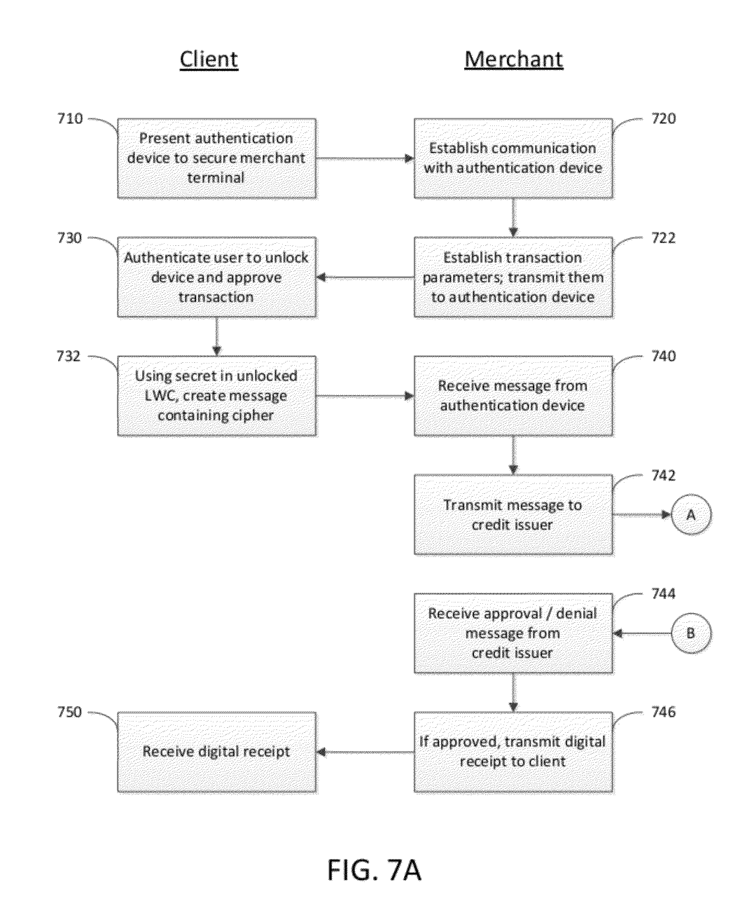

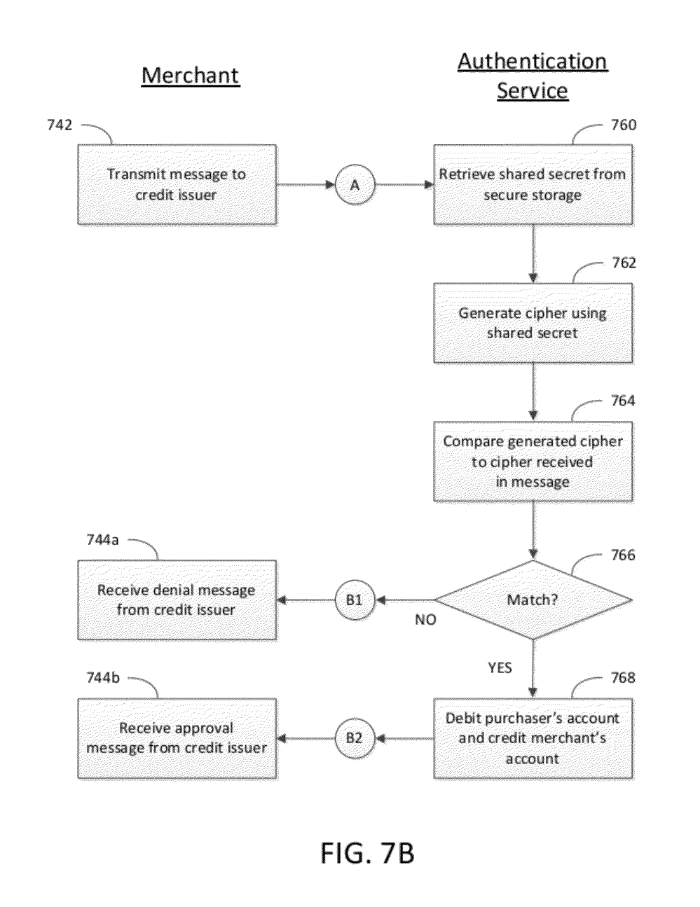

A light-weight certificate may be used to securely transact business, as shown in FIGS. 7A and 7B. In these Figures an individual possessing an authentication device wishes to enter a commercial transaction. For example, the individual may wish to purchase goods or services from the merchant using a credit card. From the individual's perspective, he presents an authentication device, such as a smartphone, to a secure merchant (point of sale) terminal. The authentication device then requests that he provide a password or biometric information, such as a fingerprint, to verify the transaction. A few seconds later, he receives a digital receipt indicating that the transaction has been completed. A smartphone that may be used in such a procedure is disclosed in U.S. patent application Ser. No. 12/267,065.

The merchant, on the other hand, must verify the identity of the individual to prevent credit card fraud that might result in a costly charge-back. For this reason, the merchant is also called the “relying party” in the transaction, because he or she must rely on the individual's proof of identity. To verify the individual's identity, the merchant requests that the authentication device create an encrypted message that only that particular individual and device can generate. The merchant then verifies the identity of the individual by sending the message to a trusted authentication service, such as that of the issuer. In order for the authentication device to create such an encrypted message, the encryption key must be unlocked by the individual providing a biometric or password, as described above. For added security, the merchant may require that this be done in his or her presence. The message that the merchant receives from the authentication device may be encrypted in such a way that the merchant (or importantly, a third party attacker) cannot see the meaningful contents of the message. For example, the message may be encrypted by the authentication device using a public encryption key of the issuer, which the authentication device may obtain and validate using methods known in the art.

FIG. 7A is a schematic block diagram showing the client-facing processes of an exemplary merchant transaction using the matched pair of encryption keys. In process 710, the individual presents an authentication device to a secure merchant terminal. To provide a concrete example, the authentication device may be a smartphone carrying a smartcard or other token facility, although other electronic devices may be used in accordance with embodiments of the invention.

In process 720, the merchant terminal establishes secure two-way data communication with the authentication device. Communication may be by way of Bluetooth, near-field communication, cellular communication, physical contact, radio-frequency communication, or a wired connection (for example). During this process, the merchant terminal may request the identity or contact information of the credit issuer—it is not necessary for the merchant to request the individual's credit card number or bank account number. In an improved, alternate embodiment, the merchant terminal may comprise a web server, and the two-way data communication may be achieved over a data communication network such as the Internet. This improvement allows the method to operate across great distances, and does not require that the purchaser or the authentication device be present at a vending site.

In process 722, the merchant device establishes transaction parameters, such as a cost and a stock keeping unit (SKU) of an item or service for sale. The merchant terminal transmits this transaction-specific information to the authentication device using the secure local link.

In process 730, the authentication device receives this message, and requires the individual to provide information unique to the individual, such as a password or biometric information in order to confirm the transaction. For example, a message box may appear on the individual's smartphone, asking whether to proceed and providing YES and NO choices. If the individual is not already logged into the phone, the phone must first be unlocked using information unique to the individual. In this way, the system guarantees that only the correct individual (that is, the one who is able to unlock the phone) may generate a proper cipher.

In process 732, once the individual has entered this information and agreed to the transaction, the shared secret is unlocked. For example, a smartphone may have a smartcard or other token facility that can only be unlocked by receiving fingerprint data or a PIN. In some embodiments, the information used to unlock the phone (such as the PIN) also unlocks the smartcard. In other embodiments, the smartcard may itself be embedded in a plastic credit card or other similar vehicle, rather than a smartphone. In these embodiments, the individual inserts the card into a point-of-sale device, and then provides a PIN or a fingerprint to the device to unlock the smartcard. Any information that is unique to the individual may be used to unlock the smartcard. Once the smartcard is unlocked, the LWC contained within, and hence the shared secret, may be accessed.

Once the shared secret is unlocked, the token facility applies a mathematical function to the shared secret in order to create a transaction cipher. Typically, this function will use a transaction sequence number, that counts how many transactions have used this shared secret. For example, if the shared secret is a seed for a pseudo-random number generator (PRNG), then process 732 repeatedly applies the PRNG algorithm a given number of times to the seed according to the sequence number to produce a pseudo-random number that serves as the transaction cipher. (Alternatively, to save time, the last generated number may be stored in the smartcard, and the PRNG algorithm is applied once to the stored number while the sequence number is incremented.) As an improvement, the PRNG algorithm may be stored in an application provided by the issuer. As another improvement, the PRNG algorithm may be executed twice, so that the transaction cipher is actually a pair of pseudo random numbers.

For additional security, the shared secret may be a list of transaction ciphers, such as a one-time pad. A one-time pad may be created by repeatedly executing a PRNG, by sampling a non-deterministic physical noise source, or by any other method. In embodiments that use a one-time pad, process 732 indexes the list according to the sequence number to select the cipher. Other methods may be used in this manner without departing from the scope of the invention disclosed herein. For even more added security, the sequence number may be non-sequentially increased. As long as the sequence number increases monotonically, then both the authentication device and the server may save storage space by discarding data pertaining to previously used sequence numbers.

To complete process 732, the authentication device creates a message containing the cipher generated by the token facility and the sequence number, if any, and transmits the message to the merchant. The message may include any other information sufficient to allow the authentication server to recreate the cipher, such as the purchaser's telephone number, billing address, login name, biometric data, or other identifier that is separate from the purchaser's account number. If desired, this message may be encrypted according to methods known in the art, including public key cryptography, but such encryption is not necessary. As noted above, such encryption prevents third parties (including the relying party) from obtaining this information. However, if the improved Internet embodiment is used to facility a CNP transaction, a digitally signed MAC address or an Internet Protocol (IP) address may be included to ensure security of the message through the data communication network.

The merchant terminal receives the message in process 740. In process 742, the merchant forwards the message to the authentication service as a transaction request, along with data identifying the merchant to the authentication service. Typically, a credit issuer or bank provides the authentication server, and the data is a merchant account number, although other indicia such as a merchant tax number may be used. After a process such as that shown in FIG. 7B, described more fully below, the merchant receives a reply in process 744. This request-reply message pair may be sent according to any number of secure methods such as using public key cryptography. If the outcome is successful then the transaction has been processed, and money or credit has been transferred from the purchaser's account to the merchant's account. The merchant may send a digital receipt or other confirmation of the transaction to the purchaser in process 746. This is received by the authentication device in process 750.

Thus, embodiments of the invention may be used to allow an individual to perform a transaction on credit, without having an authentication device in hand. In process 722 of such an embodiment, the merchant requires that the individual provide some data tied to their account number, for example a telephone number, a billing address, and biometric data. The server sends this information to a trusted third party, with whom the individual has previously established a token facility, such as virtual smartcard as disclosed in U.S. patent application Ser. No. 12/267,065. As before, the merchant may provide this information to the third party in an encrypted message and receive an encrypted response in accordance with a public key infrastructure. Provided that the individual has entrusted the LWC to this third party, the third party may authenticate the individual using this data. If the individual is authenticated, the third party uses the virtual smartcard token facility to perform the functions required to generate the cipher ordinarily sent by the authentication device in process 732. In this alternate embodiment, however, the cipher is returned to the merchant in process 740 not by the authentication device, but by the third party. As before, the message having the cipher may be encrypted (by the third party) to prevent others from accessing its useful contents. Once the merchant has received the cipher, the process of FIG. 7A continues normally with process 742. In this embodiment, the merchant may provide a digital receipt to the trusted third party in process 746, as the individual does not possess an authentication device on which to store such a receipt.

FIG. 7B is a schematic block diagram showing the server-facing processes of the exemplary merchant transaction of FIG. 7A. Processes 742 and 744 are shown, as in FIG. 7A. As before, the merchant transmits a message to the authentication service (credit issuer) in process 742. Recall that the message contains a cipher (and sequence number), a purchase amount, a purchaser identifier other than the credit or debit account number, and merchant identification data (e.g. a merchant account number). In process 760 the credit issuer retrieves the shared secret associated with the purchaser from a secure storage arrangement. For example, the credit issuer uses the purchaser identifier to locate the shared secret in a database established during the processes of FIG. 4, the database being accessible only to the credit issuer. Once the shared secret has been retrieved, in process 762 the credit issuer generates a cipher using the shared secret and the received sequence number, according to the method associated with that individual's LWC. For example, the credit issuer may only issue certificates that use pseudo-random number generators, in which case the credit issuer generates the cipher using the PRNG described in the LWC.

In process 764, the credit issuer compares the cipher it generated in process 762 with the cipher that the merchant transmitted in process 742. If these match, then the credit issuer may have a high degree of certainty that the cipher originated from the holder of the LWC. If the ciphers do not match, then the credit issuer may undertake fraud prevention steps, such as placing a fraud alert on the credit account. As shown in decision 766, if there is no match, the merchant receives a denial message from the credit issuer in process 744a. If there is a match, in process 768 the credit issuer debits the purchaser's numbered account and credits the merchant's numbered account using the purchase amount transmitted by the merchant. Finally, in process 744b the merchant receives an approval message from the credit issuer. In either case, the actual account number is never transmitted to the merchant. If required, the issuer transmits alternate purchaser identification data, as described above in connection with processes 352, 446, and 636.

Embodiments according to FIGS. 7A and 7B are secure, in part, because a credit card number is no longer valid by itself to authorize a transfer of funds from the card holder without the validating cryptography. Further, because each transaction is associated with a transaction ID received from the authentication device at the time of sale, it is very difficult for a malicious merchant to place a false debit request. All communications between the server and either the user or the merchant may use strong security which ensures that only the intended receiver can read messages intended for them. All messages in the system also may be digitally signed by the sending party, adding another layer to the overall security. Yet all of these processes are automatic and transparent to the individual and the relying party, allowing for ease of use.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A method for engaging in a transaction with an individual having possession of a credit or debit card, the card having a primary account number digitally encoded thereon, the primary account number being uniquely associated with an issuer, the method comprising:
in a transaction acquiring device, receiving the primary account number using a first input and receiving an encryption seed using a second input, the encryption seed having been previously obtained from the issuer by an authentication device of the individual, wherein the individual must pass an authentication challenge of the authentication device before the encryption seed may be received by the transaction acquiring device;
in the transaction acquiring device, applying a one-way hash function to a combination of the primary account number and the encryption seed, thereby producing a transaction hash;
transmitting the transaction hash and encryption seed to the issuer using a data communication network according to a financial transaction standard, wherein the primary account number is not transmitted to the issuer; and
receiving, from the issuer using the data communication network according to the financial transaction standard, an indication that the issuer recovered the primary account number from the transaction hash.

2. A method according to claim 1, wherein the authentication device is a smartphone.

3. A method according to claim 1, wherein the authentication challenge comprises entry of a username and password into the authentication device.

4. A method according to claim 1, wherein receiving the primary account number comprises passing the card through a magnetic stripe reader.

5. A method according to claim 1, wherein the transaction acquiring device includes a numeric keypad and receiving the encryption seed comprises use of the numeric keypad.

6. A method according to claim 1, further comprising deleting all electronic storage of the primary account number within the transaction acquiring device.

7. A method according to claim 1, wherein the primary account number is recovered from the transaction hash by using the hash to retrieve a record from a database indexed by transaction hashes, the record including the primary account number and the received encryption seed.

8. A method according to claim 1, further comprising receiving, from the issuer using the data communication network according to the financial transaction standard, an indication that the transaction is authorized.

9. A method for authorizing a requested transaction, the method comprising:
in an initialization phase:
generating an encryption seed in response to receiving a request from an authentication device of an individual, wherein the individual must pass an authentication challenge of the authentication device before the request may be received,
forming an issuer hash by applying a one-way cryptographic hash function to a combination of the generated encryption seed and a primary account number that is uniquely associated to the individual, and
storing a record in a database, the record including the issuer hash, the primary account number, and the generated encryption seed; and
in a transaction phase occurring after the initialization phase:
receiving a transaction request from a merchant that includes an encryption seed and a transaction hash,
retrieving, from the database, a record that includes the transaction hash; and
determining to authorize the transaction only if the received encryption seed matches an encryption seed contained in the retrieved record.

10. A method according to claim 9, wherein the encryption seed is obtained from a pseudorandom number generator.

11. A method according to claim 9, wherein the transaction phase further comprises:
retrieving the primary account number of the individual from the record;
retrieving a transaction amount from the transaction request; and
determining to authorize the transaction only if a balance associated with the primary account number is greater than the transaction amount.

12. A method according to claim 9, further comprising generating identification data that are unique to the individual but different from the primary account number of the individual.

13. A method according to claim 12, further comprising transmitting a determined authorization and the identification data to the merchant.
